(19) United States
(12) Patent Application Publication
(10) Pub. No.: US 2013/0272164 A1
(43) Pub. Date: Oct. 17, 2013

(54) SYSTEMS AND METHODS OF WI-FI ENABLED DEVICE CONFIGURATION

(71) Applicant: ECONAIS AE, Rio Patras (GR)

(72) Inventors: Dimitrios Leonardos, Rio Patras (GR); Nikolaos Vokas, Attiki (GR)

(73) Assignee: eConais AE, Rio Patras (GR)

(21) Appl. No.: 13/865,106

(22) Filed: Apr. 17, 2013

Related U.S. Application Data
(60) Provisional application No. 61/625,667, filed on Apr. 17, 2012.

(51) Int. Cl. H04W 8/22

(52) U.S. Cl. CPC H04W 8/22
USPC 370/254

(57) ABSTRACT

Systems and methods of configuration of Configuration Target Wi-Fi enabled devices are disclosed. The present invention applies to Configuration Target Wi-Fi enabled client devices that implement a method that allows their fast configuration over the air. The configuration parameters include but are not limited to the name of a wireless network to connect after the completion of the configuration and the credentials they may need if an authentication mechanism is used for secure connection. The method uses standard 802.11 management frames that carry useful configuration information in a predefined format and the said management frames are broadcasted by a single source (Configurator) and are received by one or many wireless stations (Configuration Targets) that have the capability to parse the contents of the management frames and retrieve the configuration information.

### CROSS REFERENCE TO RELATED APPLICATION

This application is related to and claims the benefit of U.S. Provisional Patent Application Ser. No. 61/625,667 (“the '667 application”), titled “SYSTEMS AND METHODS OF WI-FI ENABLED DEVICE CONFIGURATION,” and filed 17 Apr. 2012, which is incorporated by reference herein in its entirety for all purposes.

### BACKGROUND

IEEE 802.11 is a set of standards for implementing wireless local area network (WLAN) computer communication in various unlicensed frequency bands, like the 2.4, 5 GHz or 60 GHz frequency bands. These standards are created and maintained by the IEEE LAN/MAN Standards Committee (IEEE 802). The fourth revision of the standard, IEEE 802.11-2012 consolidates 10 amendments to the base standard that were approved since IEEE 802.11's last full revision, in 2007. This provides the basis for wireless network products using the Wi-Fi™ brand name.

### Wi-Fi 802.11 Frames

The 802.11 standard defines various frame types that stations (network interface cards (NICs) and access points) use for communication, as well as for managing and controlling the wireless link. Every frame has a control field that depicts the 802.11 protocol version, frame type, and various indicators, such as whether encryption is on, whether power management is active, and so on. In addition, all frames contain media access control (MAC) addresses of the source and destination devices, a frame sequence number, frame body and frame check sequence (for error detection).

### A. Data Frames

802.11 data frames carry protocols and data from higher layers within the frame body. For example, a 802.11 data frame could be carrying the HTML code from a Web page, formatted according to the Transmission Control Protocol/Internet Protocol (TCP/IP). At the destination, the HTML code is extracted from the TCP/IP frame that is included in the body of the 802.11 data frame. Other frames that stations use for management and control carry in the frame body specific information regarding the wireless link. For example, a beacon's frame body contains the service set identifier (SSID), timestamp, and other pertinent information regarding the access point.

### B. Management Frames

802.11 management frames enable stations to establish and maintain communications. The following are common 802.11 management frame subtypes:

Authentication frame: 802.11 authentication is a process whereby the access point either accepts or rejects the identity of a radio NIC.

Deauthentication frame: A station sends a deauthentication frame to another station if it wishes to terminate secure communications.

Association/Reassociation request frame: 802.11 association enables the access point to allocate resources for and synchronize with a radio NIC. A NIC begins the association process by sending an association request to an access point. This frame carries information about the NIC (e.g., supported data rates) and the SSID of the network it wishes to associate with.

Association/Reassociation response frame: An access point sends an association response frame containing an acceptance or rejection notice to the radio NIC requesting association.

Disassociation frame: A station sends a disassociation frame to another station if it wishes to terminate the association.

Beacon frame: The access point periodically sends a beacon frame to announce its presence and relay information, such as timestamp, SSID, Security and other parameters regarding the access point to radio NICs that are within range. Radio NICs continually scan all 802.11 radio channels and listen to beacons as the basis for choosing which access point is best to associate with.

Probe request frame: A station sends a probe request frame when it needs to obtain information from another station. For example, a radio NIC would send a probe request to determine which access points are within range. This is commonly referred as “scanning”.

Probe response frame: A station will respond with a probe response frame, containing capability information, supported data rates, etc., after it receives a probe request frame.

### C. Control Frames

802.11 control frames assist in the delivery of data frames between stations. The following are common 802.11 control frame subtypes:

Request to Send (RTS) frame;

Clear to Send (CTS) frame;

Acknowledgement (ACK) frame: The receiving station will send an ACK frame to the sending station if no errors are found.

### Information Elements

Information in the above frames is carried in one or more 802.11 Information Elements (IEs). By definition, an IE is a part of the management frames in the IEEE 802.11 wireless LAN protocol. A device uses IEs to transfer descriptive information about itself inside management frames. There are usually several IEs inside each such frame, and each is built of Type-length-value elements (TLVs) mostly defined outside the basic 802.11 specification.

The common structure of an IE is as follows:

TABLE 1
Information Element structure

| | No. of Bytes | | | |
|---|---|---|---|---|
| | 1 | 1 | 3 | 1-252 |
| Purpose | Type | Length | OUI | Data |

An organizationally unique identifier (OUI) is only used when necessary to identify the protocol being used, and the data field holds the TLVs (Type-length-value element) relevant to that IE.

### Service Set Identifier (SSID)

With wireless LANs, a service set identifier (SSID) is a label that distinguishes one wireless LAN from another. An SSID contains up to 32 alphanumeric characters, which are case sensitive. SSID is included in various management frames such as beacons and probe requests in the form of an SSID IE, check below:

TABLE 2
SSID IE

No. of Bytes per field

| | 1 | 1 | Length |
|---|---|---|---|
| Name of fields | Type: 0 | Length: 0-32 | Data |

### Scan Operation

An 802.11 station periodically performs scan operations to detect basic service set (BSS) networks that are within radio range of a network interface card (NIC).

When scanning, the 802.11 station detects a BSS network by receiving 802.11 Beacon or Probe Response frames transmitted by an access point (AP) or peer station. The Beacon and Probe Response frames contain information elements (IEs), such as a service set identifier (SSID), which identify the BSS network. The 802.11 station will use these IEs when performing a ‘connect’ or roaming operation. For the scan operation (active scan method), the 802.11 station broadcasts an 802.11 Probe Request frame for each SSID it is trying to locate by setting the SSID IE of that frame to the SSID that the station is trying to locate. If the station is scanning for all SSIDs, it sets the SSID IE to the zero-length broadcast SSID value.

### Wi-Fi Security

There are a number of security mechanisms for wireless networks. The most common types of wireless security are Wired Equivalent Privacy (WEP), Wi-Fi Protected Access (WPA) and Wi-Fi Protected Access II (WPA2). WPA and WPA2 support two modes of operation, enterprise and personal. From now on we will focus on the Personal mode of these security methods, also known as WPA Pre-shared Key Mode (WPA-PSK). These methods use a security key or passphrase to encrypt 802.11 data. The key must be known to the user prior to the association with an Access Point or retrieved from a configuration method (e.g., WPS, see ‘Wi-Fi Configuration Methods’).

### Wi-Fi Connection

An 802.11 station can connect to an Access Point using the SSID and the Security Key or passphrase. There are cases that more connection credentials are needed to establish a connection with an Access Point, but these are the minority.

### Wi-Fi Configuration Methods for Home Networks

The connection credentials are usually provided to the user in order to connect to the preferred network. For simple setup reasons and because not all the Wi-Fi enabled devices support user input (e.g. keyboard, touch screen, etc.), a number of configuration methods have been introduced in order to allow such devices to connect with a Wi-Fi network.

Wi-Fi Protected Setup (WPS) is the most common configuration protocol, which includes a number of methods with the most popular being the PIN and Push Button Methods. In the PIN Method, a Personal Identification Number (PIN) has to be read from either a sticker or the display on the new wireless device. This PIN must then be entered at the “representant” of the network, usually the Access Point of the network. Alternately, a PIN on the Access Point may be entered into the new device.

In the Push-Button-Method, the user simply has to push a button, either an actual or virtual one, on both the Access Point (or a registrar of the network) and the new wireless client device.

Another configuration method is through a Configuration Web Page in the device. This means that the device needs to have a built-in web server and that you have to connect to the device with your computer to access this page. The connection can be wired or wireless. In case of wireless, the only Wi-Fi method is by initiating an 802.11 Ad-hoc connection. Instead of the Web page, an application can be used as well for the configuration.

These methods have a number of limitations and disadvantages. For example in case of WPS, you have to initiate the process in both ends (device and Access Point). Also you cannot use WPS if the device doesn't have any input method (display, keyboard, button) or even virtual button. Using the other configuration method (ad-hoc connection) it becomes too difficult to the user. Finally, both configuration methods have to be applied on each device separately and this becomes inefficient and problematic when multiple devices in the same area have to be configured.

### SUMMARY OF THE INVENTION

The present invention is directed to an innovative configuration method, known by the trademark ProbMe, that can be applied to any appropriately adapted WLAN device (referred to herein as a Configuration Target) and is extremely useful for WLAN devices that do not provide one or more of the following capabilities: a Human Interface like a Display or a Keypad; a Peripheral port to read configuration data from an external device (e.g., USB, SDIO etc); or be easily accessible after the installation (e.g., a WLAN enabled speaker on the roof of a building). For instance, Access Points can use this method to trigger WPS as well.

In accordance with aspects of the invention, an embodiment of the current invention comprises a Configuration Target (e.g., WLAN enabled device, WLAN Station) that may be configured to process the SSID IE octets, which are embedded in any 802.11 management frame that, according to the 802.11 protocol, can carry such information. As previously mentioned, three 802.11 management frames can carry an SSID value and those are the Beacon, the Probe Request and the Probe Response Frames.

The processing of the SSID by the Configuration Target WLAN Station that receives this information, aims to identify a pattern in the first bits of the SSID, which is a unique pattern of the ProbMe method, and it is called ProbMe Identifier (PMID). As soon as the PMID is encountered, the WLAN Station will interpret the remaining bits of the SSID octets as bits carrying configuration information. Once the WLAN Device to be configured has parsed the management frame, identified valid PMID, and extracted the configuration data, the Configuration Target stores them, e.g., to non-volatile memory, and it may switch modes, from unconfigured to configured mode. Even in configured mode, the Configuration Target may be reconfigured if it detected again a valid PMID with configuration data different from the previous data.

In accordance with other aspects of the invention, another embodiment of the invention comprises a method comprising triggering the Configuration Target WLAN Station to initiate an authentication session in order to connect to an Application Access Point (AAP) that supports the authentication method in the range of the WLAN Station. The contents of the configuration bits of the SSID following the PMID specify which authentication protocol will be used.

In accordance with still other aspects of the invention, a further embodiment of the current invention includes a method to configure a Configuration Target WLAN Station to which the user has no proximity or the WLAN Station does not have means like a display or a keypad for the user to enter data. Once the Configuration Target WLAN Station is configured, it can initiate a connection process in order to associate to an AAP. One of the main advantages of the method is that any WLAN enabled computing system such as a smart phone, a laptop or a desktop can be used as the ‘Configurator.’ Such a computing system does not require any special application, changes in the hardware, or changes in software to support the method because the user can follow simple steps to enable the Configurator to broadcast an 802.11 management frame with a special purpose SSID. A user can enable the Configurator to send directly a Beacon or a Probe Request and indirectly a Probe Response as set forth below.

In accordance with additional aspects of the invention, an additional embodiment of the invention may include a system comprising a Configurator and a Configuration Target WLAN Device. The Configurator may be any device that comprises an 802.11 Medium Access Controller (MAC), 802.11 Baseband and 802.11 RF units, be adapted to broadcast SSID information and be configurable to include configuration information in the SSID information. The Configuration Target WLAN device to be configured may comprise 802.11 enabled MAC, Baseband and RF units and be capable of parsing the SSID information carried by an 802.11 management frame that is transmitted by the Configurator and received by the WLAN device to be configured. The SSID information that will be parsed by the WLAN device to be configured contains configuration data that the WLAN device to be configured will use in configured mode to connect with a peer device. The peer device may be an Access Point (AP) or a Group Owner (GO) according to the Wi-Fi Direct specification.

In accordance with still additional aspects of the invention, a still further embodiment of the invention may include a computer program product comprising a tangible computer-readable storage medium and a computer-readable program stored on the tangible computer-readable storage medium, wherein the computer-readable program contains computer-executable instructions adapted to cause a processor: to identify a special pattern in SSID information received in an 802.11 management frame as an indicator that the SSID information comprises configuration information; to parse the configuration information from the SSID information; and to configure a Configuration Target WLAN Device using the configuration information. The computer-executable instructions may be further adapted to configure the 802.11 management frame to include the SSID information having the configuration information according to 802.11 protocols; and to wirelessly transmit the configuration information in 802.11 management frames.

### BRIEF DESCRIPTION OF THE DRAWINGS

By reference to the appended drawings, which illustrate exemplary embodiments of this invention, the detailed description provided below explains in detail various features, advantages and aspects of this invention. As such, features of this invention can be more clearly understood from the following detailed description considered in conjunction with the following drawings, in which the same reference numerals denote the same elements throughout. The exemplary embodiments illustrated in the drawings is not intended to be to scale and is not to be considered limiting of its scope, for the invention may admit to other equally effective embodiments.

FIG. 1 depicts a network system according an exemplary embodiment of the invention.

FIG. 2 depicts another network system according another exemplary embodiment of the invention.

FIG. 3 depicts a block diagram of functionality of a WLAN Station according a further exemplary embodiment of the invention.

FIG. 4 depicts another block diagram of functionality of another WLAN Station according an additional exemplary embodiment of the invention.

The details of exemplary embodiments of the invention are set forth in the accompanying drawings and the description below. Other features, objects, and advantages of the invention will be apparent from the description and drawings, and from the claims.

### DETAILED DESCRIPTION

A Beacon frame can be sent when the user forces the Configurator to create a new WLAN network either in ad-hoc mode known as IBSS in 802.11 or as a Wi-Fi Direct Group Owner (GO) with a special formatted network name, which represents the SSID in the beacon. If the first characters of that name form a valid PMID, the WLAN Stations within the range of the network will detect that name after a scan operation.

A Probe Response frame with the ProbMe specific SSID name will be sent by the Configurator as a response to a Probe Request message that the Configurator receives, once a WLAN network has been established by the Configurator as described in the previous paragraph.

A Probe Request packet can be sent by a Configurator if the user forces a directive scan, i.e., a scan operation for a specific SSID. That specific SSID name which should start with the PMID followed by valid configuration data, will be broadcasted by a Probe Request Frame

In total, the following frames can be used in ProbMe method: a Beacon or a Probe Request frame broadcasted by the Configurator to many Configuration Target WLAN Stations; and a Probe Response frame transmitted by the Configurator to a single Configuration Target WLAN Station.

In most of the cases, the use of the Beacon and the Probe Response frames of the Configurator may be preferred over the Probe Request frame because the parsing of the Probe Request frame by the WLAN Device to be configured may require changes in the firmware of the WLAN chip of the said Device but this is not always feasible. On the contrary, when the Configurator has established a network with the special SSID name of the ProbMe method, the functionality executed by the Configuration Target WLAN Device to be configured does not have to change since the default operation of the said device according to IEEE 802.11 assures that the beacon information that is received by that device is processed when the device is scanning for neighboring 802.11 networks.

Those who are familiar with the 802.11 technology will recognize that a Configurator may be any device incorporating an 802.11 transceiver that is able to transmit one of the aforementioned 802.11 management frames whose contents are directly or indirectly controlled by a user's configuration data. An Access Point could also be a Configurator for a WLAN station since a user with administration rights can specify the SSID name through a web page, SNMP, telnet or other similar methods. Note, the same Access Point can initially be used as the Configurator and then as the AAP.

The current invention comprises also application software running on the Configuration Target WLAN Station to be configured that does one or both of the following: Periodically scans for neighboring WLAN networks and parses the SSID names that are embedded in the Beacon frames or the Probe Response frames received as a result of the passive or active scan respectively; and Parses the SSID names received by Probe Request frames broadcasted by the Configurator.

The configuration method of the current invention may also trigger the WPS protocol between the Configuration Target WLAN Station to be configured and an AP or a GO. The WLAN Station is the Enrollee for the WPS method and the reception of the ProbMe SSID can be considered a Virtual Push Button trigger method for WPS in addition to those defined by the Wi-Fi Alliance (PIN, Push Button, NFC etc). The WLAN Device to be configured, as soon as it successfully receives a ProbMe SSID, may indicate that it has been triggered using, for instance, an LED that will switch on and then the user will have to push the button on the Access Point (or a registrar of the network) and the actual session of the WPS protocol will start.

Example format of the ProbMe SSID can be seen below (other formats can be used as well):

TABLE 3
ProbMe SSID (32 Octets)

| | | | | | | |
|---|---|---|---|---|---|---|
| No. of Bytes per | 2 | 1 | 1 | SSID | 1 | 32-SSID length-5 |
| field | | (optional) | | length | | |
| Name of fields | PMID | Mesh | SSID | SSID | Security | Key |
| | | | Length | | | |

Wherein: PMID: a unique ID, e.g., ‘EC’

Mesh: Enable data propagation. (If the third byte of ProbMe SSID equals to 0xAA, data propagation is enabled. Otherwise it's disabled and the specific byte represents the SSID Length.)

### SSID Length: Length of the SSID

SSID: SSID string

### Security: 0->None, 1->WEP40, 2->WEP104, 3->WPA/WPA2, 4->WPS Virtual Button, 5->WPS

PIN Method, 6-254->reserved
Key: Network key (WEP or WPA) or PIN number (WPS)

Example ProbMe SSID: EC17my_ssid3passphrase. This can be analyzed as:

### PMID: EC

Mesh: Propagate data, acting as a Configurator

### SSID Len: 7

SSID: my_ssid

### Security: 3 (WPA/WPA2)

Key: passphrase

There are limitations using this method in the max SSID and Key length: Max SSID length is 32-5-key bytes (or 32-4-Key bytes if Mesh is disabled); Max Key length is 32-5-ssid bytes (or 32-4-ssid bytes if Mesh is disabled). For example, if the SSID is 6 bytes, then passphrase should be no more than 22 bytes. Although there are cases that SSID and Key size limitations exist using this method, this method covers more than 90% of home network configurations.

### Advantages Over Other Methods

ProbMe is a highly recommended configuration method for installations wherein several Configuration Target 802.11 enabled client devices have to communicate with an Access Point or another device acting as a Group Owner according to Wi-Fi Direct standard. Those Configuration Target client devices can be anything from a thermostat to a smart power meter, from a stereo speaker to a media player or from a surveillance camera to a home security system. Such devices often do not have a User Interface (UI) for configuration or the UI has limited capabilities. Moreover, it is a laborious and time consuming task to configure all the devices one by one.

Among the possible advantages presented by the present invention described herein, as compared to other methods, are the following:

Easy configuration from any Wi-Fi enabled device. The user only needs to scan for a ProbMe SSID.

No need to put devices in Ad-Hoc mode and use static IP's.

No need to trigger anything in the Access Point

Enables configuration of multiple Configuration Target devices at once.

Enables configuration of Configuration Target devices that are not in proximity of the Configurator by propagating configuration data between WLAN devices using a Mesh Network Topology.

Requires no input method in the Configuration Target device (display, keyboard, button).

### Discussion of the Drawings

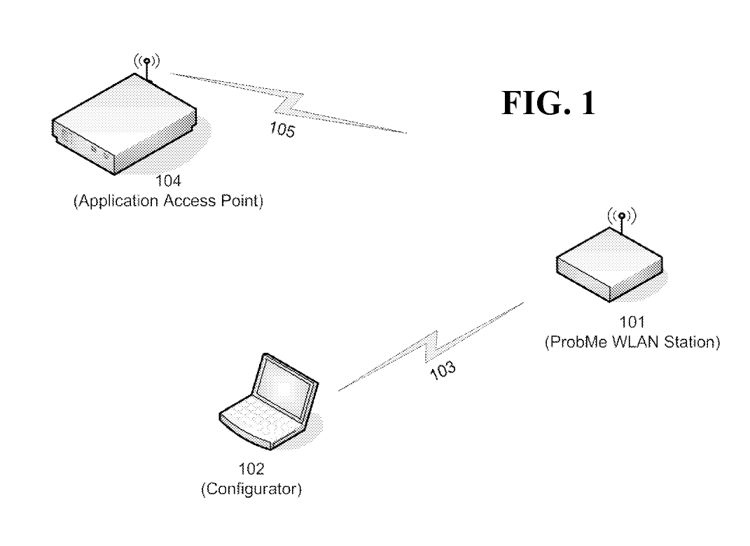

In FIG. 1, the devices that are involved in the ProbMe configuration method are shown. According to the method description, the Configuration Target WLAN Station 101 implements the ProbMe method and it can be configured by the Configurator 102 which is forced to broadcast 802.11 management frames on the air link 103. Configurator 102 can create a wireless network on air link 103 if it is configured in IBSS mode of 802.11 or as a Wi-Fi Direct Group Owner (GO). In this case, it will periodically broadcast Beacon Frames or it should transmit Probe Response 802.11 frames upon the reception of Probe Request 802.11 management frames from Configuration Target WLAN Station 101 or other similar devices in the same area. According to the method, those Beacon or Probe Request frames will include the name of the SSID, which is the ProbMe SSID format, i.e., has a unique prefix and/or a unique suffix (ProbMe tail). Configuration Target WLAN Station 101, once it detects the ProbMe SSID by using the prefix and/or suffix identifiers, will then process the remaining bytes. In order for WLAN Station 101 to connect with an Application Access Point (AAP) 104 of FIG. 1, the processing of the ProbMe SSID must lead to a valid detection of the SSID name of the network 105, which is the network that AAP 104 has created. Then, WLAN Station 101 will use one of the authentication methods specified by the contents of the ProbMe SSID. The authentication method may be any of the Wi-Fi methods like WPS, WPA/WPA2 or similar like the WAPI.

As explained in the description of the ProbMe method, the ProbMe Configuration Target WLAN Station may also be configured based on the processing of the ProbMe SSID, which is included in Probe Request 802.11 management frames. The Configurator 102 can transmit these frames even when that has not created a wireless network with the ProbMe SSID name. In this case, a Configurator 102 may or may not be connected as a WLAN Station 101 to an Access Point like the AAP 104, provided that a user forced a directive Scan, i.e., a Scan for a wireless network with the ProbMe SSID name. In that way, the Configurator 102 will transmit in all channels Probe Request frames which will include the ProbMe SSID name. Then, the ProbMe Configuration Target WLAN Station 101, if it is not in sleep mode, will listen to that frame and proceed with its processing as it has already been described.

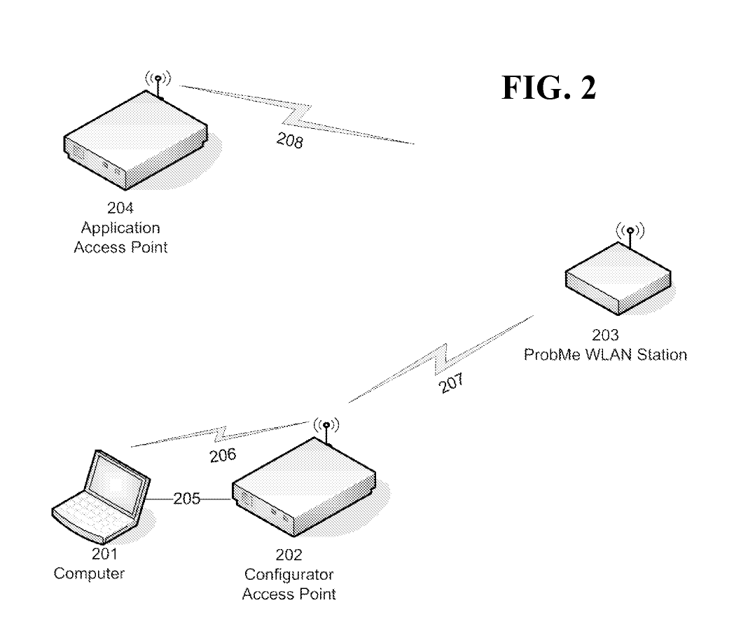

In FIG. 2, an Access Point 202 plays the role of the Configurator in case a user's computing system cannot create an IBSS network or does not support the Wi-Fi Direct GO operation. The Configurator Access Point (CAP) can be programmed by a computer with administrator rights to create a wireless network 207 with the ProbMe SSID name. In this case, the ProbMe method is based on the Beacon or the Probe Response frames that are transmitted by the CAP, and the processing of those frames by the ProbMe Configuration Target WLAN Station follows exactly the steps described in FIG. 1, until it is connected to the AAP 204. It is possible that the same Access Point can be used first as a CAP and then as an AAP since the events take place sequentially.

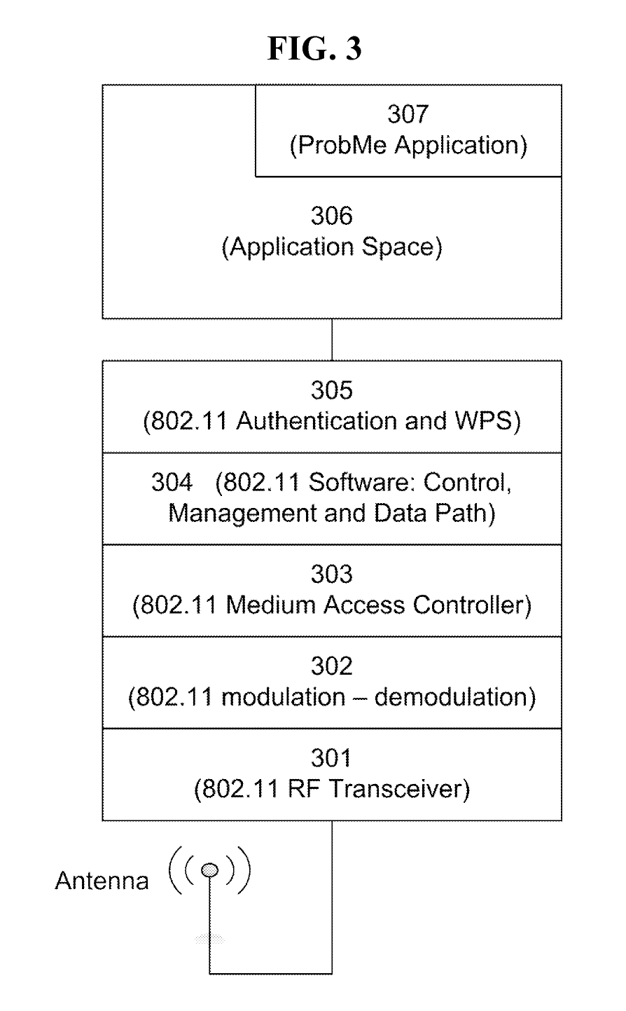

FIG. 3 depicts a block diagram of the functionality of the ProbMe Configuration Target WLAN Station, which is based on the processing of Beacon or Probe Response 802.11 management frames. It is a typical WLAN Station comprising an RF Transceiver 301, an 802.11 modem 302, an 802.11 Medium Access Control unit 303 and a Software Unit 304 for 802.11 Control, Management and Data handling. In addition, it is very common that such a Configuration Target WLAN station supports Authentication and Security protocols 305. Protocols 305 may support one or more of the Wi-Fi authentication standards like the WPA, 802.11i, WPS, Wi-Fi Direct or non IEEE authentication standards like WAPI.

This protocol stack comprising blocks 301 to 305 provides an interface to an application 306, which at least can enable a scan operation, gets the scan results and initiate an authentication session using one of the modes of protocol 305. The functionality that enables the ProbMe method can be considered part of the application that gets and parses the scan results aiming to detect a valid ProbMe SSID 307. In addition, the functionality of the ProbMe method, upon successful detection and parsing of the ProbMe SSID, will decide which Authentication Method to use. Readers with knowledge of the Scan Mechanism of the 802.11 protocol understand than the Scan Results list is formed by the Beacons received by the WLAN Station in a certain time window (Passive Scan) and/or the Probe Response 802.11 management frames that are received as responses to the Probe Request 802.11 management frames that are transmitted by a Configuration Target WLAN Station (Active Scan).

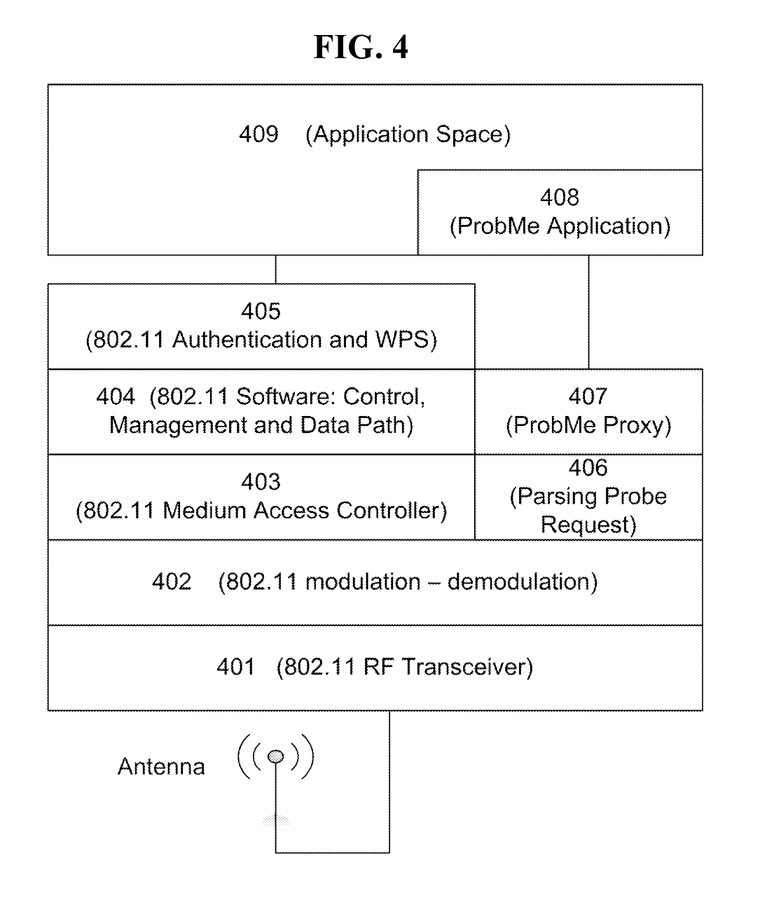

FIG. 4 depicts a Block Diagram similar to that of FIG. 3, but in this case for a ProbMe Configuration Target WLAN Station that is additionally able to parse Probe Request 802.11 frames transmitted by a Configurator. Such a Configuration Target WLAN Station may require an additional functional module 406 that resides in a lower layer of the protocol stack in the Receive path of the data. Module 406 may parse the received Probe Request frames, which would normally be rejected by a legacy WLAN station. If the parsing of those frames leads to a successful detection of a ProbMe SSID, a message will be transmitted, through a ProbMe Proxy 407 to the ProbMe Application and the sequence of the events afterwards will be the same as that described in FIG. 3.

As an 802.11-experienced reader can realize, the ProbMe method based on the Parsing of the Probe Request 802.11 management frames has some drawbacks over the ProbMe method based on the parsing of the scan results since it may require modification of the lower layers of a legacy WLAN Station that may not be always possible. In addition, it may require a Configuration Target WLAN Station that has to be configured not to be in sleep mode in order to be able to listen to the Probe Response Frames. On the contrary, when the ProbMe method is based on the Scan list created by the reception of beacon and Probe Request frames, it can stay in sleep mode and periodically enable the Scan function of the system.

In conclusion, a ProbMe Configuration Target WLAN Station may support the ProbMe method based on Beacon/Probe Request Frames and/or Probe Response Frames because it also depends on the capabilities of the Configurator.

The foregoing description discloses exemplary embodiments of the invention. While the invention herein disclosed has been described by means of specific embodiments and applications thereof, numerous modifications and variations could be made thereto by those skilled in the art without departing from the scope of the invention set forth in the claims. Modifications of the above disclosed apparatus and methods that fall within the scope of the invention will be readily apparent to those of ordinary skill in the art. Accordingly, other embodiments may fall within the spirit and scope of the invention, as defined by the following claims.

In the description above, numerous specific details are set forth in order to provide a more thorough understanding of embodiments of the invention. It will be apparent, however, to an artisan of ordinary skill that the invention may be practiced without incorporating all aspects of the specific details described herein. In other instances, specific details well known to those of ordinary skill in the art have not been described in detail so as not to obscure the invention. Readers should note that although examples of the invention are set forth herein, the claims, and the full scope of any equivalents, are what define the metes and bounds of the invention.

We claim:

1. A method for wireless configuration of a Configuration Target comprising a WLAN Device, wherein the method comprises:
configuring an 802.11 management frame to include SSID information comprising configuration information according to 802.11 protocols; and
transmitting the configuration information in 802.11 management frames wirelessly to the WLAN Device.

2. The method of claim 1, further comprising:
receiving the 802.11 management frame at the WLAN Device;
identifying a special pattern in the SSID information as an indicator that the SSID information comprises configuration information;
parsing the configuration information from SSID information in the 802.11 management frame; and
configuring the WLAN Device using the configuration information.

3. The method of claim 2, further comprising:
preparing the WLAN Device to parse the configuration information and to configure itself using the configuration information,
wherein preparing comprises implementing software, firmware, hardware, or a combination thereof.

4. The method of claim 3, wherein preparing comprises activating a ready state to receive the 802.11 management frame, to parse the configuration information, and to configure the WLAN Device.

5. The method of claim 1, wherein the SSID information included in the 802.11 management frame comprises a special pattern that is identified by the WLAN Device as SSID information associated with configuration information; and wherein the SSID information further comprises the configuration information in remaining bytes that precede or follow the special pattern.

6. The method of claim 5, wherein the configuration information further comprises authentication information.

7. The method of claim 6, wherein the authentication information is configured to trigger a WPS session between the WLAN Device and an Access Point that supports WPS Push Button method.

8. The method of claim 6, wherein the authentication information comprises:
a key,
a network name of a wireless network that is created by an Access Point; and
an authentication name of a wireless authentication method that the Access Point is using.

9. A WLAN Device comprising a 802.11 RF unit, a Modem, and a MAC layer unit, and configured to parse configuration information from SSID information in an 802.11 management frame received by the 802.11 RF unit.

10. The device of claim 9, further configured to identify a special pattern in the SSID information as an indicator that the SSID information comprises configuration information and to retrieve authentication information from remaining bytes of the SSID information.

11. The device of claim 10, further configured to trigger an authentication session according to the authentication information when the device detects the special pattern in the SSID information.

12. The device of claim 10, further comprising indication means comprising an LED, a small display, or an audio signal, wherein the indication means is configured to notify a user of the reception of the 802.11 management frame containing configuration information.

13. The device of claim 11, further configured to authenticate with an Access Point using WEP, WPA, WPA2 or Open authentication pursuant to the trigger of the authentication session.

14. The device of claim 11, further configured to perform one or more authentication methods comprising WPS Pin Method and WPS Push Button Configuration.

15. The device of claim 11, further configured to use authentication credentials parsed from the SSID information, the authentication credentials comprising a username and a password, to connect to a WPA, WPA2 or 802.1x Enterprise network using one of a plurality of EAP-Methods comprising EAP-PEAP and EAP-TTLS.

16. The device of claim 9, further configured to update an internal time using configuration information from the SSID information according to Network Time Protocol (NTP).

17. The device of claim 9, further configured to read GPS coordinates included in the SSID information and to provide location information to the device.

18. The device of claim 9, further configured to read and handle any configuration commands included in the SSID information.

19. The device of claim 9, further configured to act as a Configurator upon reading a special value in the SSID information, for use as a bridge to propagate configuration information or other authentication commands to neighboring Configuration Target devices that are not in proximity to an initial Configurator.

20. The device of claim 19, further configured to deploy a Wireless Mesh Networking technique for data propagation.

21. The device of claim 9, further configured to act as a gateway for transmitting to a WLAN or WAN data received in the SSID information from a remote WLAN device that is not connected to the WLAN because the remote WLAN device is not in proximity to a WLAN router or Access Point; wherein the data received from SSID information originate from the remote WLAN device using standard data propagation techniques and packed using conventional algorithms.

22. A system comprising a Configurator and a Configuration Target, wherein the Configuration Target comprises a WLAN Device, wherein the Configurator comprises a first 802.11 RF unit, is adapted to broadcast SSID information and is configurable to include configuration information in the SSID information; and wherein the WLAN Device comprises a second 802.11 RF unit and is configured to parse the configuration information from the SSID information in an 802.11 management frame received by the second 802.11 RF unit from the first 802.11 RF unit.

23. The system of claim 22, further comprising an Access Point creating a wireless network with which the WLAN Device connects using the configuration information.
